(19) United States
(12) Patent Application Publication
(10) Pub. No.: US 2025/0067326 A1
(43) Pub. Date: Feb. 27, 2025

(54) COMPACT REDUCTION ASSEMBLY

(71) Applicant: Martin J. Sladek, Kirkwood, MO (US)

(72) Inventor: Martin J. Sladek, Kirkwood, MO (US)

(21) Appl. No.: 18/812,720

(22) Filed: Aug. 22, 2024

Related U.S. Application Data
(60) Provisional application No. 63/520,965, filed on Aug. 22, 2023.

(51) Int. Cl. F16H 37/02; B62M 9/02; B62M 11/02

(52) U.S. Cl. CPC F16H 37/02; B62M 9/02; B62M 11/02

(57) ABSTRACT

A compact reduction assembly has four pinions upon four shafts along with three related gears and including one chain between two of the shafts. The first shaft has a first pinion and cranks joined to it. The second shaft has a first gear and a second pinion joined to it, so the first gear enmeshes with the first pinion. The third shaft has a second gear and a third pinion joined to it, so the second gear enmeshes the second pinion. The chain spans from the third pinion to a fourth pinion on the fourth shaft and the fourth shaft thus turns a third gear delivering power. The four pinions and three gears have diameters to support up to a 50:1 gear reduction. A person or motor supplies power to the cranks of the first shaft for greater power output from the fourth shaft.

### CROSS-REFERENCE TO RELATED APPLICATIONS

This non-provisional application claims priority to provisional application Ser. No. 63/520,965 filed on Aug. 22, 2023 which have a common inventor.

### BACKGROUND OF THE INVENTION

The present invention relates to gear boxes in compact form. The compact reduction assembly has particular utility generating greater torque than that provided by an input, such as a cyclist's legs or a small motor.

The compact reduction assembly is desirable for increasing the torque output from the assembly thus accelerating a bicycle or other machine.

From the early bicycles through those of the late 1800s onwards, cyclists have wanted to go faster, faster, and faster. Cyclists have sought to increase the power that they themselves supply into the bicycle machine. Cyclists have borrowed technology from other lines of devices, particularly chain driven machinery, and contributed improved devices of their own. A pair of bicycle mechanics took the need for speed and developed that into the first aircraft, spawning all of aviation.

From time to time, a cyclist, or other small machine operator, seeks to improve a bicycle or other machine with more terrestrial application. A cyclist may utilize the slope of a hill to accelerate his bicycle using gravity. A cyclist may utilize the gearing provided with a bicycle to match the cyclist's leg power from torque applied to the crankshaft to that required by the terrain. Other machine operators utilized gear boxes and later transmissions that conditioned the power from an engine to the machine and its desired application.

### DESCRIPTION OF THE PRIOR ART

For over a century and into recent decades, people though still ride their bicycles, even on rough terrain, up hills, and in bad weather. In recent years, people have ridden their bicycles for fitness and to reach work in this country. In other countries, bicycle usage occurs more than in this country. In recent months, bicycles have now appeared for rent by the minute using a Smartphone app. Bicycles still though rely upon human power, particularly from legs for their motive source.

The U.S. Pat. App. Pub. No. 2010/0219606 to Orozco provided a drive system for a vehicle. This system has meshed gears that receive input power from a chain drive off a pedal drive gear.

Then the U.S. Pat. No. 9,114,848 to Scolari et al. illustrated a pedal drive system upon a stand-up cycle, or scooter. The system has two pedals, generally elongated and planar, each upon a two-leaf armature for a crank shaft.

Therefore, a need exists for new and improved compact reduction assembly that can be used for over a 50:1 reduction and corresponding power increase. In this regard, the present invention substantially fulfills this need. In this respect, the compact reduction assembly according to the present invention substantially departs from the conventional concepts and designs of the prior art, and in doing so provides a device primarily developed for the purpose of increasing power output using a set of reduction gears in a compact space.

The compact reduction assembly overcomes the above-mentioned disadvantages and drawbacks of the prior art. As such, the general purpose of the present invention, which will be described subsequently in greater detail, is to provide a new and improved compact reduction assembly which has all the advantages of the prior art mentioned heretofore and many novel features that result in long walk litter box which are not anticipated, rendered obvious, suggested, or even implied by the prior art, either alone or in any combination thereof.

### SUMMARY OF THE INVENTION

The present invention combines a multiple reduction drive with a compound chain drive. The multiple reduction drive reduces the required force to that possible by a human cyclist, often turning a crankshaft by hand. The compound chain drive multiplies the typical rotational effect of pedaling cadence in much the same manner as other conventional chain drives though to a greater extent. The present invention provides for a significant increase in velocity of a machine, such as a bicycle, including the invention at approximately similar pedal torques of conventional bicycle pedaling systems. Though this description refers to bicycles and pedals, this invention may also serve well on other machinery where operations call for a heightened torque output from a given input power.

The compact reduction assembly has six pinions upon four shafts including one chain between two of the shafts. The first shaft has a first pinion and cranks joined to it. The second shaft has a second pinion and a third pinion joined to it, so the second pinion enmeshes with the first pinion. The third shaft has a fourth pinion and a fifth pinion joined to it, so the third pinion enmeshes the fourth pinion. The chain spans from the fifth pinion to the sixth pinion on the fourth shaft. The six pinions have diameters to support up to a 50:1 gear reduction. A combination of two adjacent pinions may have a semi-reduction of 43% while combination of four pinons may have up to a reduction of 98%. The pinions and shafts of the invention fit within the provided space upon a frame.

An alternate embodiment of the invention includes positioning the first three shafts so that the first, second, and fourth pinions attain a triangular arrangement, perimeters upon each pinion, diameters of each pinion and numbers of perimeter teeth upon each pinion, stacking of second and third pinions upon a common shaft and of fourth and fifth pinions upon another common shaft, and a fourth shaft joining to existing gearing.

There has thus been outlined, rather broadly, the more important features of the invention in order that the detailed description thereof that follows may be better understood and in order that the present contribution to the art may be better appreciated. Additional features of the invention will be described hereinafter, and which will form the subject matter of the claims attached.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and devices for carrying out the several purposes of the present invention. It is important, therefore, that the claims be regarded as including such equivalent constructions insofar as they do not depart from the spirit and the scope of the present invention.

It is therefore an object of the present invention to provide a new and improved compact reduction assembly that may allow a cyclist to propel a bicycle at nearly 60 mph.

Another object of the present invention is to provide a new and improved compact reduction assembly that may be easily and efficiently manufactured and marketed to the consuming public.

Another object of the present invention is to provide a compact reduction assembly for increasing the lever length of the crankshaft of a bicycle.

Another object of the present invention is to provide a compact reduction assembly that divides a reduction gear.

Another object of the present invention is to provide a compact reduction assembly that provides a reduction ratio from about 50:1 to about 0.4:1.

Another object of the present invention is to provide a compact reduction assembly that saves space upon a bicycle frame.

Another object of the present invention is to provide a compact reduction assembly that fits upon a bicycle frame in the available space without interfering with a cyclist's legs and arms before, during, and after usage.

Another object of the present invention is to markedly improve the efficiency of human, animal, fossil fuel, electric, wind, and water power sources.

Another object of the present invention is to provide a compact reduction assembly that lessens the burdens and hassles upon a cyclist.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

In referring to the drawings,

FIG. 1 is a side view of the present invention installed upon a recumbent bicycle;

FIG. 2 is a side view of the present invention;

FIG. 3 is a side view of the invention opposite that of FIG. 2; and,

FIG. 4 is a top view of the present invention.

The same reference numerals refer to the same parts throughout the various figures.

### DESCRIPTION OF THE PREFERRED EMBODIMENT

For any particular single chain drive ratio at any given set of conditions, the horsepower, or hp, requirement becomes an amount X. This amount of X hp comes from the sum of the opposing forces besetting a machine including friction, or Ff, road, or Fr, slope, or Fs, air resistance including wind, or Fw, as functions of speed. The power to overcome the opposing forces of friction, rolling resistance, and slope become affected by a variable velocity and a constant weight, of a machine, which follows a linear increase with velocity increaser. Further, the power to overcome wind resistance becomes affected solely by velocity following a cubic increase, that is, v³, with each velocity increase. From these preliminaries, power equals force multiplied by velocity or

$$P = FxV . \qquad Eq . 1$$

And the total force from Equation 1 becomes the summation of the Ff, Fr, Fs, and Fw from above shown as

$$Ftotal = Ff + Fr + Fs + Fw . \qquad Eq . 2$$

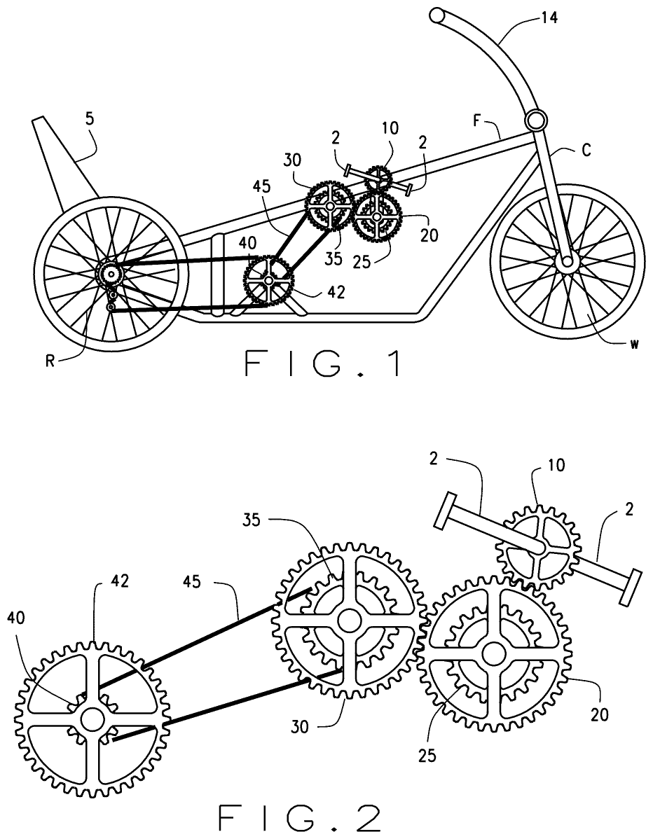

The present invention provides of approximately 80% reduction of the total force required for input into the invention to overcome Fw, Fr, and Fs at any speed. The present invention utilizes the power input by a cyclist utilized in Equation 1 for a proper step up in force from Equation 2. The present invention has lesser effect upon frictional forces, such as Ff, because the multiple reduction drive has its own friction created during its operation, however, this description views power losses due to internal friction as disregarded because of their minor role in the overall power requirement. The reduction of total force takes form upon considering the pitch diameters of the multiple reduction drive of the compact reduction assembly as later shown in FIGS. 2, 3, 4 and applying the Equation 1 where:

$$W [ l b * f t ] = Ftotal + Fr + Fs + Fw .$$

As an example,

$$Frequired = ( Ftotal \times 3 ” \times 3 ” \times 4 ” ) / ( 5 ” \times 5 ” \times 7.09 ” ) = 0.2 \times Ftotal . \qquad Eq . 3$$

Thus,

Power [from the invention]=(0.2 F total)×V=0.2×hp

Further, the diameters of the pinions also relate to the power produced as follows:

$$Power out = Power in * ( {r}_{1} \times {r}_{3} \times {r}_{5} ) / ( {r}_{2} \times {r}_{4} \times {r}_{6} ) . \qquad Eq . 4$$

Which when using the preferred diameters of the pinions and gears, expressed as radii, or half of the diameters, takes the form of:

$$Power out = Power in * ( 1.5 \times 1.5 \times 4. ) / ( 5.5 \times 5.5 \times 3.5 ) . \qquad Eq . 5$$

Because the gear train of the present invention reduces the effort, or hp requirement 80% or 0.20× or one fifth, the invention sees a comfortable chain drive ratio increase, at least five-fold. Further, increasing the horsepower, or hp, requirement to five-fold causes a mean horsepower to increase per step up from a 200 meter to a 1000-meter racing bicyclist of approximately 0.075 hp. An 80% reduction of 5×hp is a 4×reduction and 5×less 4×leaves 1×, or the hp requirement of the original chain drive. For most single chain drives, a five-fold increase in ratio though compromises practicality thus the present invention of the compact reduction assembly utilizes a compound chain drive. However, the five-fold increase in chain drive ratio represents a potential five-fold increase in rear tire rotations for the compound chain drive alone. When this sees use in combination with a gear train, the driving gears to driven gears ratio reduces the five-fold increase by 0.4 rotations per crank rotation of a two-fold increase for the entire compact reduction assembly conversion. This two-fold increase provides for a doubling of velocity per crank rotation at the same hp or effort as the prior art.

For perspective, consider two identical bicycles with two identical riders where Bike A has a conventional 4:1 step up chain drive and Bike B has the present invention. Each bike has an onboard computer that tracks cadence, in rpm, velocity in mph and fps, and power, in hp. As both cyclists travel with equal cadence, the velocity of Bike A is 0.47 fps per pedal rotation and Bike B has its velocity of 0.18 fps per pedal rotation. This disparity arises due to the relative ratios of the gear train. The overall step-up ratio for Bike A is 4:1 which means the rear wheel will revolve 4 times for each revolution of the crankshaft with pedals, and Bike B has its step-up ratio of 1.6:1. At equal velocity, Bike A pedals once for every two and a half times Bike B pedals which should pose little difficulty to a cyclist on Bike B which has a pedal torque one fifth, or 20%, of Bike A. As a further example, consider Bike B* having a 5:1, 4:1 step up compound chain drive ratio. As both riders travel with equal cadence, the velocity of Bike A becomes 0.46 fps per pedal rotation while Bike B* has 0.94 fps per pedal rotation of the crankshaft. Both cyclists then confirm an equal cadence and horsepower output such that Bike B* travels with double the velocity of Bike A. Similarly, if both cyclists travel with equal velocity, Bike B* will have to reduce its cadence to half that of Bike A and thus reduces the power requirement in half. These examples appear in Table 1.

TABLE 1

| | Bike A | Bike B | Bike B* |
|---|---|---|---|
| Step up Ratio | 4:1 | 4:1, 0.4:1 | 5:1, 4:1, 0.4:1 |
| Velocity (v) | V | V/2.5 | 2 V |
| per rpm | | | |
| Force Required | Ftotal | 0.2 Ftotal | 5 (0.2)Ftotal = |
| | | | Ftotal |
| Pedal Torque | Ftotal × r | 0.2 Ftotal × r | 5 (0.2) Ftotal × r |
| Power Required | X hp | 0.2 X hp | 5 (0.2 X hp) = X |
| | | | hp |

Furthermore, concerns related to the additional frictional forces and the weight of the components of the compact reduction assembly may exist, however, design considerations may compensate for them and make their effects negligible. As stated previously, the power losses due to friction often go ignored as of little consequence due to the small percentage, as in 1.5% to 5%, it adds to the total power required. As conventional transmissions cause 0.001 to about 0.005 hp losses, then the components of the compact reduction assembly would have an expected four-fold increase upon that amount, or 0.02 hp, because of no inherent difference in efficiency between chain drives and gear trains. But upon calculation the frictional force from the compact reduction assembly using Equation 3 for total frictional force, the required force for friction and resultant power requirement for the additional shafts, gears, bearings, and chain of the compact reduction assembly is less than the power requirement of conventional single chain drives, 0.0008 to about 0.004 hp. With regards to the additional weight of the components of the compact reduction assembly, the same argument holds as before where the relatively small increase in friction has little consequence, especially when using low density and high strength alloys or polymers and composites with gear face width, pitch, quality, and tooth form designed for an intended usage of 1000 to about 2000 hours of operation, maximum 1 to about 2 hp, and 0.1 to about 0.3 hp operating ranges.

Referring now to the drawings, and particularly to FIG. 1, a preferred embodiment of the compact reduction assembly of the present invention is shown by the reference numeral 1. In FIG. 1, the present invention 1 installs upon a bicycle frame F. Though a bicycle frame appears in the drawing, the invention may install in other machinery for transmission of power. The bicycle frame connects to a set of handlebars H shown towards the right that then connect to a front fork C. The front fork has a front wheel attached to it that rotates conventionally. The handlebars appear to the right of the invention in this figure. The frame F continues to the left of the invention 1 where a seventh pinion 41 then G connects to a conventional chain and derailleur. Inwardly into the plane of this figure from the derailleur, the frame connects to a rear wheel R conventionally. Proximately the rear wheel R, the bicycle frame has a seat S. The present invention has a position upon the frame typically as shown ahead of the seat at a comfortable distance for operation by the legs of a person. The invention 1 has two radial cranks 2 spaced apart upon a common axis where the axis has a perpendicular orientation to the frame, that is, out of the plane of this figure. The cranks attach to a first pinion 10. The first pinion has a disc like, or round, shape with teeth upon its perimeter. In an alternate embodiment, though the drawings show cranks 2 attaching to the first pinion, the first pinion may also receive an output shaft from a motor, or an engine. The teeth of the first pinion mesh with a first gear 20 also of a disc like shape of greater diameter than the first pinion. The first gear also has teeth upon its perimeter for enmeshing with the first pinion. Inwardly, the first gear 20 has a second pinion 25 or spur pinion, shown in phantom. The second pinion also has a round shape with teeth upon its perimeter. The second pinion has a lesser diameter than the first pinion. The second pinion then enmeshes with a second gear 30, or spur gear, which has a similar diameter to that of the first gear 20. The second gear also has a perimeter with teeth upon it. Inwardly, the second gear has a third pinion 35 or sprocket, shown in phantom. The third pinion also has its round shape with a toothed perimeter. The third pinion has a lesser diameter than the second gear. The third pinion then takes up a continuous chain 45 transmitting power rearward along the frame to a fourth pinion 40, or sprocket. This sprocket then transmits power and torque to a third gear 42. The continuous chain 45 operates in tension during its usage.

The third gear 42 then further transmits power using a conventional bicycle chain into a derailleur or other mechanism. Additionally, each pinion, as at 10, 25, 35, 40 and gear, as at 20, 30, 42 has teeth of greater depth and width than the prior art. The deeper and wider teeth withstand bending, deflection, misalignment, or flexion imparted to them from the bicycle frame F, related housings, or chain guards. Each pinion, as at 10, 25, 35, 40 and gear, as at 20, 30, 42 has its round form, preferably hollow with supporting struts, or alternatively solid, with its teeth upon the perimeter. In the preferred embodiment, the teeth of each pinion and gear have a flat, or blunted tip, and beveled faces widening outward from the tip towards the center of a pinion. The pinions and gears have a tooth count from thirty teeth to sixty teeth evenly spaced about the perimeter of a pinion. In one embodiment, a seven inch diameter pinion or gear has thirty five teeth, a nine inch diameter gear or pinion has forty five teeth, and an eleven inch diameter gear or pinion has fifty five teeth. In another embodiment, each pinion and each gear has a key at its center the secures under a setscrew to its corresponding shaft.

FIG. 2 shows a side view of the invention 1 separated from the frame F for clarity. As suggested in FIG. 1, the first pinion 10, the first gear 20, and the second gear 30 have a compact form with the first gear positioned inward and upward from the first pinion and the second gear. This positioning fits the invention within the length of the frame, the vertical room of the bicycle, and maintains the desired gear reduction ratios. More particularly, the compact reduction assembly utilizes four parallel precision ground shafts for holding its components to the frame F while transmitting power. The shafts appear on end in this view and in more detail later in FIG. 4. A first shaft, or the crank shaft for the cranks 2, supports one 0.8 module, approximately 9.52 mm face width, approximately 20-degree pressure angle, approximately 115.2 mm pitch diameter, approximately 144 tooth spur pinion with aluminum pin hub and set screw, or the first pinion 10. The spur pinion may be made of metal or polymer such as Delrin® being made by Delrin USA of Auburn Hills, Michigan. The first pinion 10 meshes with one 0.8 module approximately 9.52 mm face width, approximately 20-degree pressure angle, approximately 128 mm pitch diameter, approximately 160 tooth spur pinion with aluminum cluster hub and set screw, or the first gear 20 upon a second shaft. Additionally upon the second shaft adjacent to the first gear 20 is another 0.8 module approximately 9.52 mm face width, approximately 20 degree pressure angle, approximately 115.2 mm pitch diameter, approximately 144 tooth spur pinion, or the second pinion 25 meshing with another 0.8 module approximately 9.52 mm face width, approximately 20 degree pressure angle, approximately 128 mm pitch diameter, approximately 160 tooth spur gear with aluminum pin hub and set screw or second gear 30 upon a third shaft. The spur gear may be made of metal or polymer such as Delrin®. Also, upon the third shaft, the invention has one approximately 3.831 inch pitch diameter, approximately ⅝ inch bore with ⅝ inch to 12 mm bore reducer, approximately 24 tooth polymer sprocket, or third pinion 35 for a ½ inch pitch dimension metal chain 45, or alternately a polymer chain. Here ⅝ inch refers to 0.625 inch. Spaced away from the third pinion to the left, the invention includes a fourth shaft that supports an approximate 1.462 inch pitch diameter, approximate ½ inch bore with ½ inch to 10 mm bore reducer, approximate 9 tooth polymer sprocket, or fourth pinion 40, joined to the sprocket or third pinion 35 of the third shaft by the chain 45. Here ½ inch refers to 0.500 inch. The bearings of the present invention's pinions, gears, and sprockets include shielding with tolerances of at least ABEC 7 (ISO Class 4) where ABEC means Annular Bearing Engineering Committee of Alexandria, VA. The shafts, pinions, gears, and sprockets of the invention fit within a frame F that provides rigidity and alignment for proper operation of the gear train and compensation for backlash or recoil.

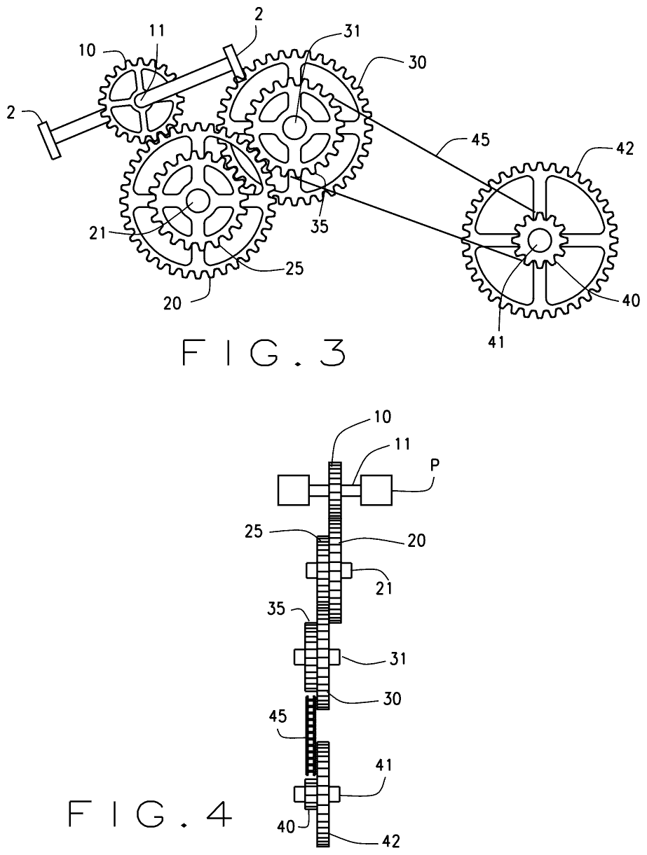

Opposite FIG. 2, FIG. 3 shows a side view of the invention with the direct path of power transmission visible. The power transmission path begins with the cranks turning the first pinion 10 that enmeshes the first gear 20 simultaneously turning second pinion 25 that then enmeshes with the second gear 30 that then turns the third pinion 35 or sprocket. The third pinion then takes up the chain 45 transmitting power to the fourth pinion or sprocket 40 that then simultaneously turns the third gear 42. As suggested in FIG. 2, the four pinions turn upon shafts. The first pinion turns upon a first shaft 11, the first gear and second pinion turn upon a second shaft 21, the second gear and the third pinion turn upon the third shaft 31, and the third gear 42 and the fourth pinion turn upon a fourth shaft 41. The four shafts are mutually parallel, with three shafts in a triangular arrangement, and a fourth shaft spaced apart along the frame of the bicycle to accommodate the diameters of the various pinions and the length of chain. The shafts are generally perpendicular to the length of bicycle as shown in FIG. 1. The designation of the invention as compact comes from use of smaller gears, or pinions, in diameter and tooth count through the reduction of force necessary to propel the bicycle C. The triangular arrangement of the three shafts also promotes compact form as in minimum volume occupied. The present invention with its arrangement of pinions has less weight than prior art gear assemblies and thus contributes to faster travel of the bicycle C.

Changing the point of view upwardly from FIG. 3, FIG. 4 shows a top view of the invention as seen by a cyclist. As noted above, the compact reduction assembly utilizes four parallel precision ground shafts. The first shaft 11, or the crank shaft, has two radially opposite cranks with a pedal P upon each end. The first shaft has an approximately 15 mm diameter and an approximately 3.0 inch length and the first shaft joins to the first pinion 10. The first pinion then enmeshes with the first gear 20 joined to the second shaft 21 of approximately 10 mm diameter and an approximately 3.0 inch length. The second shaft 21 has adjacent to the first gear, the second pinion 25 here shown to the left of the first gear 20. Then the second pinion enmeshes with the second gear 30 joined to the third shaft 31 here shown below the third pinion. The third shaft has a diameter of approximately 12 mm and an approximate length of 3 inches. Also, upon the third shaft, the invention has the third pinion 35, or sprocket that takes up the chain 45 here partially shown. The third pinion joins to the third shaft. The chain then spans downward in the figure to the fourth pinion 40 or sprocket joined to the fourth shaft 41 of approximately 10 mm diameter and approximate three-inch length. The fourth shaft then joins to the third gear 42 for power transmission into the remainder of the bicycle. The invention has its first gear being concentric with the second pinion, the second gear being concentric with the third pinon, and the third gear being concentric with the fourth pinion. Moreover, as shown in this figure, the invention has its first pinion, the first gear, and the third gear in the same plane, or being coplanar.

In the preferred embodiment, the first pinion, the first gear, the second pinion, and the second gear have a ratio of 3:11:3:11 which leads to a 92% reduction. In alternate embodiment, the first pinion, the first gear, the second pinion, and the second gear have a ratio of 2:11:2:11 which leads to a 97% reduction. Further, the linear arrangement of the pinions and the gears reduces flexural forces imparted to the frame F, and related structure of the bicycle C.

In an alternate embodiment, the first pinion has at least a 6 inch diameter, the first gear has at least an 8 inch diameter, the second pinon has at least a 6 inch diameter, the second gear has at least an 8 inch diameter, the third pinon at least a 10 inch diameter, the third gear has at least a 6 inch diameter, and the fourth pinion has at least a 1.5 inch diameter.

The shafts, pinions, and related gears form a compound gear assembly. The gear assembly includes a gear cluster. This assembly allows a cyclist to access all three gears, four pinions of the invention of the gear cluster, and existing gearing of bicycle mount of the invention. Moreover, the chain 45 cooperatively engages a derailleur in mutual precision alignment so that the gear assembly may shift during usage without jamming the derailleur or jumping the chain from the third gear 40 or the third pinion 35. The gear assembly thus permits a cyclist to operate a bicycle equipped with the invention upon city streets, hills, tracks, and a 1¼ mile oval.

In an alternate embodiment, the invention utilizes titanium gears and has a doubling of gear width and of gear pitch compared to the preferred embodiment. These alternate features seek to lessen flexure in the housing of the invention and cracking of the bore in the gears and in related mechanisms. Further, the housing of the invention includes gussets in a mutually parallel orientation or in radial orientation thus stiffening the housing to withstand impact loads during usage without imparting deflection into the pinions and gear clusters. The gussets may take the form of linear ribs, half tubes, T shaped members, select corrugations, and the like used as reinforcement and as vibration suppression.

The present invention in its preferred and alternate embodiments stands ready to serve cyclists, motorcycle riders, snowmobile riders, and operators of various other equipment and vehicles that utilize chain drive with human motive power, petroleum engine power, or electric motor power.

While a preferred embodiment of the compact reduction assembly has been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly, and use, are deemed readily apparent and obvious to one skilled in the art, and all equivalent relationships to those illustrated in the drawings and described in the specification are intended to be encompassed by the present invention. For example, any suitable sturdy material such as plastic, polymer, metal, Delrin®, and composite may be used. Although providing a compact reduction assembly for a bicycle has been described, it should be appreciated that the compact reduction assembly herein described is also suitable for a motorcycle drive train, a snowmobile belt drive, and various self-propelled construction equipment, and the like.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

Various aspects of the illustrative embodiments have been described using terms commonly employed by those skilled in the art to convey the substance of their work to others skilled in the art. However, it will be apparent to those skilled in the art that the present invention may be practiced with only some of the described aspects. For purposes of explanation, specific numbers, materials, and configurations have been set forth in order to provide a thorough understanding of the illustrative embodiments. However, it will be apparent to one skilled in the art that the present invention may be practiced without the specific details. In other instances, well known features are omitted or simplified in order not to obscure the illustrative embodiments.

Various operations have been described as multiple discrete operations, in a manner that is most helpful in understanding the present invention, however, the order of description should not be construed as to imply that these operations are necessarily order dependent. In particular, these operations need not be performed in the order of presentation.

Moreover, in the specification and the following claims, the terms “first,” “second,” “third” and the like—when they appear—are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to ascertain the nature of the technical disclosure. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

As such, those skilled in the art will appreciate that the conception, upon which this disclosure is based, may readily be utilized as a basis for the designing of other structures, methods, and systems for carrying out the several purposes of the present invention. Therefore, the claims include such equivalent constructions insofar as they do not depart from the spirit and the scope of the present invention.

1. A compact reduction assembly, comprising:
a first pinion upon a first shaft, said first pinion having a diameter and a perimeter, said first pinion having a plurality of teeth radially extending and spaced along its perimeter;
a first gear upon a second shaft and a second pinion inwardly from said first gear upon said second shaft, said first gear having a diameter and a perimeter and a plurality of teeth radially extending and spaced along its perimeter, said second pinion having a diameter and a perimeter and a plurality of teeth radially extending and spaced along its perimeter;
a second gear upon a third shaft and a third pinion inwardly from said second gear upon said third shaft, said second gear having a diameter and a perimeter and a plurality of teeth radially extending and spaced along its perimeter, said third pinion having a diameter and a perimeter and a plurality of teeth radially extending and spaced along its perimeter;
a continuous chain enmeshing with said third pinion;
a third gear upon a fourth shaft and a fourth pinion inwardly from said third gear upon said third shaft, said third gear having a diameter and a perimeter and a plurality of teeth radially extending and spaced along its perimeter, said fourth pinion having a diameter and a perimeter and a plurality of teeth radially extending and spaced along its perimeter, and said fourth pinion enmeshing with said continuous chain opposite said third pinion; and
wherein power input to said first shaft increases at least twentyfold to said fourth shaft during usage of the invention.

2. The compact reduction assembly of claim 1 further comprising:
said first shaft, said second shaft, said third shaft, and said fourth shaft being mutually parallel.

3. The compact reduction assembly of claim 2 further comprising:
said first pinion, said first gear, and said second gear have a triangular arrangement.

4. The compact reduction assembly of claim 3 further comprising:
said third gear locating below and away from said second gear.

5. The compact reduction assembly of claim 1 further comprising:
said first pinion enmeshing with said first gear; and
said second pinion enmeshing with said second gear.

6. The compact reduction assembly of claim 5 further comprising:
said first gear being concentric with said second pinion;
said second gear being concentric with said third pinon; and
said third gear being concentric with said fourth pinion.

7. The compact reduction assembly of claim 6 further comprising:
said first pinion, said first gear, and said third gear being coplanar.

8. The compact reduction assembly of claim 1 further comprising:
said first pinion having an approximately 9.52 mm face width, approximately 20 degree pressure angle, approximately 115.2 mm pitch diameter, no more than 144 teeth;
said first gear having an approximately 20 degree pressure angle, approximately 128 mm pitch diameter, no more than 160 teeth;
said second pinion having an approximately 9.52 mm face width, approximately 20 degree pressure angle, approximately 115.2 mm pitch diameter, no more than 144 teeth;
said second gear having an approximately 9.52 mm face width, approximately 20 degree pressure angle, approximately 128 mm pitch diameter, no more than 160 teeth;
said third pinion having an approximately 3.831 inch pitch diameter, approximately ⅝ inch bore with ⅝ inch to 12 mm bore reducer, no more than 55 teeth;
said fourth pinion having approximately 1.462 inch pitch diameter, approximately ½ inch bore with ½ inch to 10 mm bore reducer, no more than 55 teeth; and
said third gear having an approximately 9.52 mm face width, approximately 20 degree pressure angle, approximately 128 mm pitch diameter, no more than 160 teeth.

9. The compact reduction assembly of claim 1 further comprising:
said first shaft having an approximately 15 mm diameter and an approximately 3.0 inch length;
said second shaft having an approximately 10 mm diameter and an approximately 3.0 inch length;
said third shaft having a diameter of approximately 12 mm and an approximate length of 3.0 inches; and
said fourth shaft having an approximately 10 mm diameter and approximately 3.0 inch length.

10. A compact reduction assembly, comprising:
a first shaft, a second shaft, a third shaft, and a fourth shaft being spaced apart and mutually parallel;
a third gear upon said fourth shaft and a fourth pinion inwardly from said third gear upon said third shaft, said third gear having a diameter and a perimeter and a plurality of teeth radially extending and spaced along its perimeter, said fourth pinion having a diameter and a perimeter and a plurality of teeth radially extending and spaced along its perimeter;
a continuous chain enmeshing with said third pinion and said fourth pinion enmeshing with said chain opposite said third pinion;
a second gear upon said third shaft and a third pinion inwardly from said second gear upon said third shaft, said second gear having a diameter and a perimeter and a plurality of teeth radially extending and spaced along its perimeter, said third pinion having a diameter and a perimeter and a plurality of teeth radially extending and spaced along its perimeter;
a first gear upon said second shaft and a second pinion inwardly from said first gear upon said second shaft, said first gear having a diameter and a perimeter and a plurality of teeth radially extending and spaced along its perimeter, said second pinion having a diameter and a perimeter and a plurality of teeth radially extending and spaced along its perimeter;
a first pinion upon said first shaft, said first pinion having a diameter and a perimeter, said first pinion having a plurality of teeth radially extending and spaced along its perimeter; and
wherein power input to said first shaft increases at least twentyfold to said fourth shaft during usage of the invention.

11. The compact reduction assembly of claim 10 further comprising:
said first pinion enmeshing with said first gear; and
said second pinion enmeshing with said second gear.

12. The compact reduction assembly of claim 11 further comprising:
said first gear being concentric with said second pinion;
said second gear being concentric with said third pinon; and
said third gear being concentric with said fourth pinion.

13. The compact reduction assembly of claim 10 further comprising:
said first pinion, said first gear, and said second gear have a triangular arrangement.

14. The compact reduction assembly of claim 13 further comprising:
said third gear locating below and away from said second gear.

15. The compact reduction assembly of claim 14 further comprising:
said first pinion, said first gear, and said third gear being coplanar.

16. The compact reduction assembly of claim 15 further comprising:
said first pinion having an approximately 9.52 mm face width, approximately 20 degree pressure angle, approximately 115.2 mm pitch diameter, no more than 144 teeth;
said first gear having an approximately 20 degree pressure angle, approximately 128 mm pitch diameter, no more than 160 teeth;
said second pinion having an approximately 9.52 mm face width, approximately 20 degree pressure angle, approximately 115.2 mm pitch diameter, no more than 144 teeth;
said second gear having an approximately 9.52 mm face width, approximately 20 degree pressure angle, approximately 128 mm pitch diameter, no more than 160 teeth;
said third pinion having an approximately 3.831 inch pitch diameter, approximately ⅝ inch bore with ⅝ inch to 12 mm bore reducer, no more than 55 teeth;
said fourth pinion having approximately 1.462 inch pitch diameter, approximately ½ inch bore with ½ inch to 10 mm bore reducer, no more than 55 teeth; and
said third gear having an approximately 9.52 mm face width, approximately 20 degree pressure angle, approximately 128 mm pitch diameter, no more than 160 teeth.

17. The compact reduction assembly of claim 15 wherein said first pinion has at least a 6 inch diameter, said first gear has at least an 8 inch diameter, said second pinon has at least a 6 inch diameter, said second gear has at least an 8 inch diameter, said third pinon at least a 10 inch diameter, said third gear has at least a 6 inch diameter, and said fourth pinion has at least a 1.5 inch diameter.

18. A compact reduction assembly, comprising:
a first pinion upon a first shaft, said first pinion having a diameter and a perimeter, said first pinion having a plurality of teeth radially extending and spaced along its perimeter;
a first gear upon a second shaft and a second pinion inwardly from said first gear upon said second shaft, said first gear having a diameter and a perimeter and a plurality of teeth radially extending and spaced along its perimeter, said second pinion having a diameter and a perimeter and a plurality of teeth radially extending and spaced along its perimeter;
a second gear upon a third shaft and a third pinion inwardly from said second gear upon said third shaft, said second gear having a diameter and a perimeter and a plurality of teeth radially extending and spaced along its perimeter, said third pinion having a diameter and a perimeter and a plurality of teeth radially extending and spaced along its perimeter;
a continuous chain enmeshing with said third pinion;
a third gear upon a fourth shaft and a fourth pinion inwardly from said third gear upon said third shaft, said third gear having a diameter and a perimeter and a plurality of teeth radially extending and spaced along its perimeter, said fourth pinion having a diameter and a perimeter and a plurality of teeth radially extending and spaced along its perimeter, and said fourth pinion enmeshing with said continuous chain opposite said third pinion;
said first shaft, said second shaft, said third shaft, and said fourth shaft being mutually parallel;
said first pinion enmeshing with said first gear, and said second pinion enmeshing with said second gear;
said first gear being concentric with said second pinion, said second gear being concentric with said third pinon, and said third gear being concentric with said fourth pinion;
said first pinion, said first gear, and said third gear being coplanar;
wherein power input to said first shaft increases at least twentyfold to said fourth shaft during usage of the invention.

19. The compact reduction assembly of claim 18 further comprising:
said first pinion, said first gear, and said second gear have a triangular 5 arrangement;
said third gear locating below and away from said second gear;
wherein said first pinion has at least a 6 inch diameter, said first gear has at least an 8 inch diameter, said second pinon has at least a 6 inch diameter, 10 said second gear has at least an 8 inch diameter, said third pinon at least a 10 inch diameter, said third gear has at least a 6 inch diameter, and said fourth pinion has at least a 1.5 inch diameter.
